(19) United States
(12) Patent Application Publication
(10) Pub. No.: US 2008/0141516 A1
(43) Pub. Date: Jun. 19, 2008

(54) ARTIFICIAL TURF SYSTEM AND METHOD OF MAKING

(76) Inventors: Henry A. Julicher, Valley Forge, PA (US); Joseph W. DiGeronimo, Sturbridge, MA (US); Bruce Cheskin, Wayne, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/612,429

(22) Filed: Dec. 18, 2006

(51) Int. Cl. B23P 17/00

(52) U.S. Cl. 29/419.1

(57) ABSTRACT

A recreational surface such as an artificial turf playing field includes a pile fabric having a backing and a multiplicity of generally upstanding pile elements, and an infill overlying the backing and being interspersed between the upstanding pile elements. The infill advantageously includes resilient particles as well as particles of a rubber coated hard granular material such as rubber coated sand. The particles of rubber and the particles of rubber coated sand may be mixed together or they may be applied separately in different courses or layers in which the relative proportions of the two types of particles differ. Also disclosed is a method of designing and constructing such a recreational surface in which the properties of the recreational surface are specified according to the intended use of the recreational surface. For example, the impact resistance properties of the recreational surface may be engineered by adjusting the relative proportions of resilient particles and particles of rubber coated hard granular material.

### BACKGROUND OF THE INVENTION

1. Field of the Invention

This invention relates generally to the field of synthetic recreational surfaces and processes that are used to fabricate such surfaces. More specifically, this invention relates to an improved artificial turf system and methods that may be used to fabricate such a system.

2. Description of the Related Technology

Synthetic recreational surfaces include indoor and outdoor surfaces that are designed for walking, running, sporting events or other recreational activities. They include walkways, running tracks, and artificial turf installations.

Processes for fabricating an early synthetic grass or turf for applications such as outdoor miniature golf courses have been known since at least the 1930s, but it was not until the mid-1960s that an artificial turf system was developed that was adequate to serve as a playing surface for rigorous sports such as football and baseball. This first truly modern artificial turf system, which was eventually installed in the Houston Astrodome, was developed by Monsanto and was disclosed in U.S. Pat. No. 3,332,828 to Faria et al.

Early artificial turfs such as that disclosed in the Faria et al. patent relied upon one or more layers of elastomeric material to provide cushioning against impact with the turf. This tended to give the turf a spongy feel that players felt was unpleasant. It also made early artificial turfs unsuitable for certain sports related applications, such as golf greens. The solution to this problem was first introduced in the mid-1970s in U.S. Pat. No. 3,995,079 to Haas, Jr., which disclosed a synthetic turf like product that included a pile fabric having a relatively flexible backing and generally upstanding pile elements resembling grass as well as a granular infill or top dressing material interspersed on the backing among the pile elements of the pile fabric. The granular infill or top dressing was disclosed as preferably being installed to a depth that was sufficient to substantially absorb the shock of objects impacting thereon.

The motivation for the use of the infill technique in the Haas, Jr. patent was to provide an artificial turf surface that had property suitable for use as a golf course green. However, it was soon recognized that the infill technique provided superior characteristics for artificial turf playing surfaces for more rigorous sports as well. The preferred material for use in the infill, however, continued to evolve. The original Haas, Jr. patent described the use of relatively coarse, hard materials such as crushed granite to form the infill, which gave the resulting turf a crunchy feel and tended to abrade against the pile elements or artificial grass blades. Haas, Jr. improved on the original technology in U.S. Pat. No. 4,044,179, which disclosed the use of multiple layers of granular material to form the infill. Specifically, a fine sand layer was first laid directly upon the backing material, dispersed among the upstanding pile elements. A coarse sand layer was then applied over the fine sand layer. The use of a moisture retention material such as vermiculate was also discussed in order that the sand would retain moisture to restrict it from shifting.

While an all sand infill was found to be superior in many respects to in infill formed of coarser hard materials, it also had disadvantages. After extended use, the sand would tend to compact and become quite hard, losing its resiliency. The turf would increasingly become less comfortable for the players and would eventually have to be replaced. Sand compaction also tends to negatively impact the ability of the artificial turf to drain itself during heavy rains.

Impact testing (commonly referred to as Gmax testing) is used to measure the shock-absorbing properties of recreational surfaces, including artificial turf. Gmax values express a ratio: the ratio of the maximum acceleration (deceleration) experienced during an impact with the surface undergoing testing, to the normal rate of acceleration due to gravity. The higher the Gmax value, the lower the shock-absorbing properties of the surface. Gmax measurements are an important measurement of the playability and safety of an artificial turf playing field. The most commonly used Gmax testing standard is the one established by the American Society for Testing and Materials (ASTM). For synthetic surfaces, the ASTM specifies that the average Gmax value of one or more test points on a field should not exceed 200 Gmax (as measured in accordance with ASTM procedures F355-A and F1936). If Gmax level of over 200 is measured, the field is considered unsafe and remediation is required.

Removal and replacement of the compacted sand top dressing is a difficult, time-consuming and expensive process because the compacted top dressing material becomes closely packed together with the upstanding artificial grass fibers and is difficult to remove.

In the early 1980s, Haas, Jr. developed an infill or top dressing, as disclosed in U.S. Pat. No. 4,337,283, which included resilient particles, preferably fabricated from granulated cork or synthetic rubber, that were mixed with harder granular materials such as sand. This improved the cushioning of the artificial turf and reduced frictional abrasion to players and objects when impacting the turf. The sand that was used in such infills was raw uncoated silica sand, which in practice has been found to be potentially unsafe because it can cause silicosis.

U.S. Pat. No. 5,958,527 to Prevost discusses an artificial turf assembly includes having a top dressing or infill having a base course that is first placed upon the top surface of the backing and consists exclusively of hard sand granules. A middle course of intermixed hard sand and resilient rubber granules is then placed upon the base course. A top course exclusively of resilient rubber granules is then placed upon the middle course. The base sand course is represented to hold the turf in place and to quickly drain the surface. The middle layer of mixed sand and rubber granules was said to act as a buffer to keep the base sand and top rubber courses separated.

It has been found by those in the industry that artificial turf systems that utilize a mixed sand and rubber infill will eventually degrade so as to have undesirable shock absorbing characteristics. Such systems are typically measured to have Gmax ratings approximately within the range of about 180 to about 200. While these values are not so high as to require immediate remediation, they represent close to the minimum acceptable standard of impact resistance for an athletic field. Concerned coaches, athletes and administrators typically prefer an athletic field that has greater impact resistance (which will be expressed as a lower Gmax rating) than is commonly achieved using a mixed sand and rubber infill because of safety and performance issues.

Sprinturf of Wayne, Pa. has more recently pioneered a top dressing or infill that is fabricated entirely from elastomeric materials. This is commonly known as the all rubber infill. An all rubber infill can be more expensive than using sand or a mixture of sand and rubber, but it provides certain distinct advantages and may be cooled if the rubber is colored. An all rubber infill feels and reacts more like a natural turf soil base than a mixture of sand and rubber does. It will not overcompact like sand, so the shock absorbing characteristics of the all rubber infill turf will not significantly degrade over time. In other words, the measured Gmax rating of the artificial turf using an all rubber infill will not increase dramatically over time like those systems that utilize a sand infill or a mixture of sand and rubber. Artificial turf systems utilizing an all rubber infill are commonly tested to have a Gmax rating that is approximately within a range of about 100 to about 130.

Another advantage of eliminating sand from the infill material stems from the fact that sand is a relatively porous material that is believed by some to be susceptible to absorption of biocontaminants (fungus, algae, bacteria, urine, blood, saliva, excrement, etc.) that can cause bacterial and viral infestation, leading to an offensive odor or other potentially dangerous unhygienic conditions. Sand also commonly ends up in players' eyes, where it can cause abrasion damage, particularly in the case of players who wear contact lenses. An all rubber infill is much less abrasive to players and objects than is an infill utilizing sand.

U.S. Pat. No. 5,041,320 to Meredith et al., which issued in 1991, disclosed an infill or top dressing for artificial turf that uses loose mineral grains such as sand that have been coated with a polymeric material. This is commonly referred to in the industry as rubber coated sand. WO 2004/022853 to Jensen also discloses a method of making artificial grass utilizing a rubber coated sand. Rubber coated sand is well suited for artificial turf as an infill material in many respects. Because a particle of rubber coated sand tends to be denser than a particle that is fabricated entirely from rubber, theoretically rubber coated sand could provide a firmer surface in comparison to pure rubber. However, it is generally considered to be uneconomical to fabricate an infill for larger artificial turf projects such as a football field out of rubber coated sand because it is very expensive. In addition, because no coating process is perfect, rubber coated sand still tends to be more abrasive than an infill or top dressing that is fabricated entirely from rubber.

A need exists for an improved artificial turf system and a method for constructing such a system that is economical, resists compaction, minimizes abrasiveness and that provide superior shock impact resistance and stability in comparison to conventional artificial turf systems.

### SUMMARY OF THE INVENTION

Accordingly, it is an object of the invention to provide an improved artificial turf system and a method for constructing such a system that is economical, resists compaction, minimizes abrasiveness and that provide superior shock impact resistance and stability in comparison to conventional artificial turf systems.

In order to achieve the above and other objects of the invention, a method of fabricating a recreational surface according to a first aspect of the invention includes steps of determining a desired property of the recreational surface; and fabricating the recreational surface using a mixture comprising resilient particles and particles of a rubber coated hard granular material. The step of fabricating the recreational surface preferably includes selecting a relative proportion of the resilient particles with respect to the particles of a rubber coated hard granular material based on said desired property.

A method of fabricating artificial turf according to a second aspect of the invention includes steps of installing a pile fabric having a backing and a multiplicity of generally upstanding pile elements; installing a first infill layer on the backing, the first infill layer being predominantly fabricated from one of either resilient particles or particles of rubber coated hard granular material; and installing a second infill layer over the first infill layer, the second infill layer being predominantly fabricated from the other of either resilient particles or particles of rubber coated hard granular material.

According to a third aspect of the invention, a method of fabricating an artificial turf installation includes determining an intended use of the artificial turf installation; calculating an optimum shock absorbing property specification for the artificial turf installation, the step of calculating an optimum shock-absorbing property specification being performed in reliance upon the determined intended use; calculating an infill composition in reliance on the shock-absorbing property specification, the infill composition comprising a mixture of first particles having a first hardness and second particles having a second hardness that is different from the first hardness, and wherein the step of calculating an infill composition comprises determining a ratio of the first particle to the second particles; installing a pile fabric having a backing and a multiplicity of generally upstanding pile elements; and installing an infill constructed according to said calculated infill composition on the backing.

A recreational surface according to a fourth aspect of the invention includes a pile fabric having a backing and a multiplicity of generally upstanding pile elements; and an infill overlying the backing and being interspersed between the upstanding pile elements, the infill comprising resilient particles and particles of a rubber coated hard granular material.

An artificial turf installation according to a fifth aspect of the invention includes a pile fabric having a backing and a multiplicity of generally upstanding pile elements; and an infill overlying the backing and being interspersed between the upstanding pile elements, the infill comprising a first layer that is predominantly fabricated from one of either resilient particles or particles of a rubber coated hard granular material, the infill further comprising a second layer that is predominantly fabricated from the other of either resilient particles or particles of a rubber coated hard granular material.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a fragmentary perspective diagrammatical view of an artificial turf installation that is constructed according to a preferred embodiment of the invention;

FIG. 2 is a fragmentary cross-sectional view of an artificial turf installation according to a modified embodiment of the invention;

FIG. 3 is a diagrammatical cross-sectional view of a first type of infill particle according to a preferred embodiment of the invention;

FIG. 4 is a diagrammatical cross-sectional view of a second type of infill particle according to a preferred embodiment of the invention;

FIG. 5 is a diagrammatical fragmentary cross-sectional view of an artificial turf assembly that is constructed according to one embodiment of the invention;

FIG. 6 is a diagrammatical fragmentary cross-sectional view of an artificial turf assembly that is constructed according to a second embodiment of the invention; and

FIG. 7 is a flow chart depicting a method that is performed according to a preferred embodiment of the invention.

### DETAILED DESCRIPTION OF THE PREFERRED EMBODIMENT(S)

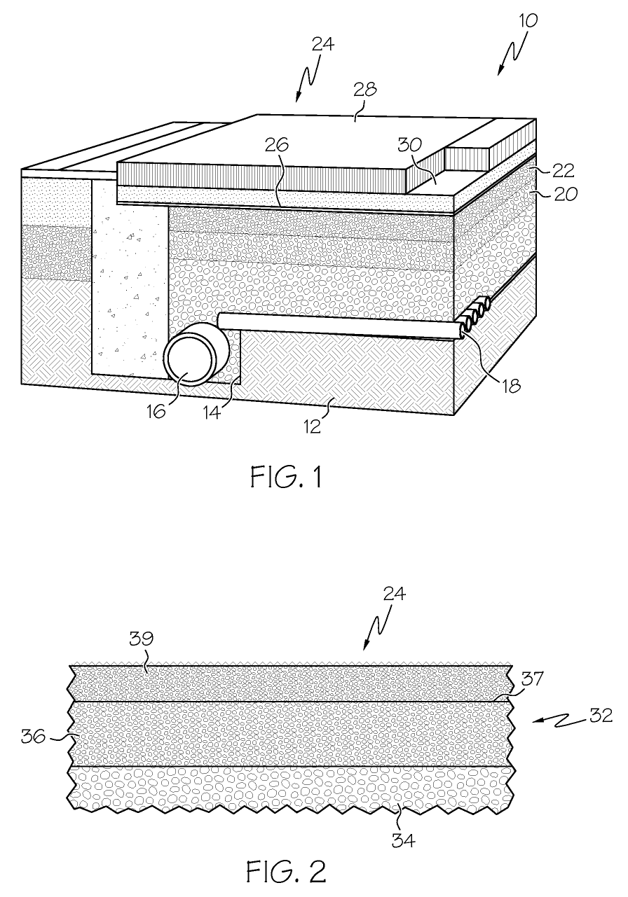

Referring now to the drawings, wherein like reference numerals designate corresponding structure throughout the views, and referring in particular to FIG. 1, an artificial turf installation 10 that is constructed according to a first preferred embodiment of the invention includes a first layer of compacted subgrade soil 12 having a plurality of trenches 14 defined therein, each of which contains a perforated drainage pipe 16. Perforated drainage pipe 16 is preferably fabricated from a plastic material. Adjacent to the trenches 14 and placed on an upper surface of the compacted subgrade 12 are a plurality of perforated panel drain members 18, which are generally oriented so as to be substantially perpendicular to the axis of the trench 14 and are designed to carry drainage water to the trench 14 and the perforated drainage pipe 16. The perforated panel drain members 18 may be wrapped in a geotextile fabric in order to prevent clogging.

A layer of coarse aggregate material 20 is preferably provided on top of the panel drain members 18. The coarse aggregate material 20 is preferably crushed stone. A second layer 22 of fine aggregate material, also preferably fabricated from crushed stone, is preferably installed on top of the layer of coarse aggregate material 20. An artificial turf assembly 24, which will be described in greater detail below, is installed on top of the fine aggregate material 22.

In an alternative embodiment of the invention that is depicted in FIG. 2, the artificial turf assembly 24 may be supported by a base installation 32 having a first sub base layer 34 that is preferably fabricated from crushed stone and a second layer 36 that is preferably fabricated from a hot mix asphalt material. A nonwoven geotextile pad 37 is placed on top of the hot mix asphalt material, and a layer of shock absorbing material 39 is installed between the nonwoven geotextile pad 37 and the artificial turf assembly 24. The layer 39 of shock absorbing material 39 is preferably comprised of synthetic rubber, an inorganic-based moisture-retaining component and a binder mixture obtained by mixing an isocyanate polyurethane and an acid.

In a preferred embodiment, the synthetic rubber may be a butadiene rubber comprising from about 100% to about 60% by weight of the composition. More preferably, the butadiene rubber is polybutadiene or styrene-butadiene rubber that preferably comprises from about 88% to about 86% by weight of the composition. Most preferably, however, the butadiene rubber is a styrene-butadiene that comprises about 86% by weight of the composition. The synthetic rubber is preferably granulized with the granules having a diameter that allows for maximum sized air voids while giving the desired degree of softness-hardness and strength. Preferably, the granule size ranges from about 6 millimeters to about 2 millimeters in diameter. A preferable source for the granulized synthetic rubber is recycled tires that are commercially available from numerous sources, such as American Recycled Tires, Midland, Mich.; TLJ, Inc., St. Louis, Mo.; W & W Recycling Rubber, Saugus, Mass. and Tire Incorporated, Charlotte, N.C. The granulized rubber is preferably comprised of granulized reinforced polycord tires with no steel present and with the polycord being comprised of nylon or polyester.

To provide an underlayment with the desirable amount of shock absorbency and traction, it is preferred that the synthetic rubber have a certain degree of softness-hardness and resiliency. To that end, it is preferable that the recycled tires have a Shore “A” hardness of about 40 to about 70 as measured by the American Standard Test and Measurements (“ASTM”) scale for tire hardness, ASTM No. D2240-68. This shore gives the granulized rubber the desired amount of softness-hardness and resiliency required in most applications. More preferably, however, the tires have a shore A of about 45 to about 65, and most preferably, have a shore A of about 50 to about 60.

The layer 39 of shock absorbing material 39 preferably has a thickness that is substantially within the range of about 12 mm to about 60 mm and more preferably within a range of about 19 mm to about 38 mm. This embodiment of the invention is preferably constructed according to the teachings that are provided in U.S. Pat. No. 5,605,721 to DiGeronimo, the entire disclosure of which is incorporated by reference as if set forth fully herein.

Referring again to FIG. 1, artificial turf assembly 24 preferably includes a pile fabric having a web like backing material 26 and a multiplicity of generally upstanding pile elements or fibers 28. Artificial turf assembly 24 also preferably includes an infill 30 that is overlying the backing material 26 and interspersed between the upstanding pile elements 28.

According to one particularly advantageous feature of the invention, infill 30 includes both resilient particles and particles 40 of a rubber coated hard granular material. A resilient particle is defined as a particle that is fabricated from a material or materials that are substantially compressible at pressures that will be applied thereto when a person is walking or running on an artificial turf installation. A resilient particle in the preferred embodiment of the invention is embodied as a rubber particle 46, but could alternatively be fabricated from another resilient material such as cork or vermiculate. A rubber particle 46 is shown diagrammatically in FIG. 4. The term “rubber” as used within this document in relation to either rubber particles or rubber coated particles is hereby defined to encompass any resilient elastomeric material, including natural and artificial rubbers and polymers such as thermoplastic polymers and equivalent materials. The rubber particle 46 that is depicted in FIG. 4 may be fabricated from any such material. Rubber particle 46 is preferably constructed so as to be substantially homogeneous in its density and composition.

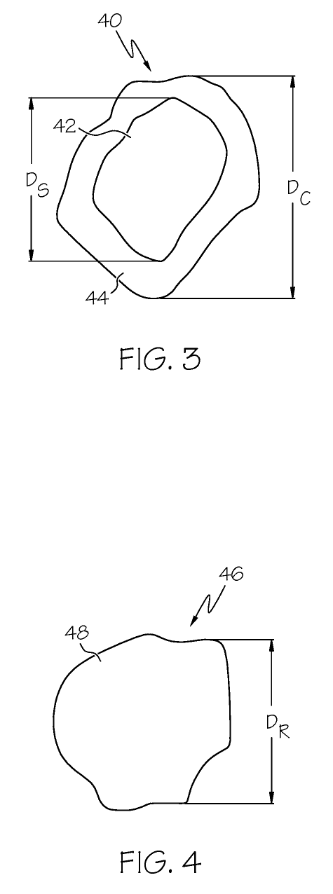

A particle 40 of rubber coated hard granular material is shown diagrammatically in FIG. 3. Particle 40 includes a core 42 of hard granular material, which may be fabricated of a metallic material, a ceramic material, a stone material, a mineral material, a hard plastic material or any other hard material. The core 42 of hard granular material preferably exhibits a Brinell hardness that is greater than about 10 and a specific gravity that is greater than 1, meaning that it would not float in water. Preferably, the core 42 of hard granular material is a particle of sand, and most preferably quartz sand. Particle 40 further includes an outer coating 44 of a rubber material as the term is defined above.

The rubber particles 46 and the particles 40 of rubber coated hard granular material are preferably of substantially the same size, and preferably have a median size that is within a range of about 8 to about 42 mesh (about 0.0937 to about 0.0139 inches). More preferably, both types of particles have a median size that is substantially within a range of about 10 to about 42 mesh (about 0.0661 to about 0.0139 inches).

Preferably, the particles 40 of rubber coated hard granular material are fabricated so that the rubber coating comprises about 2% to about 8% by weight of core 42 of hard granular material, and more preferably about 4% to about 6% by weight of the core 42 of hard granular material.

The core 42 of hard granular material is preferably quartz sand and is preferably of an overall grain diameter in the range of about 0.0039 inches to about 0.0787 inches, more preferably in the range of about 0.0078 inches to about 0.059 inches, and most preferably in the range of about 0.0156 inches to about 0.0354 inches.

Both the rubber particles 46 and the particles 40 of rubber coated hard granular material preferably have a specific gravity greater than 1, meaning that they will not float in water. Preferably, the specific gravity of the rubber particles 46 is substantially the same as the specific gravity of the particles 40 of rubber coated hard granular material.

The particles 40 of rubber coated hard granular material are preferably fabricated according to the process that is described in WO 2004/022853 to Jensen, the entire disclosure of which is hereby incorporated by reference as if set forth fully herein. In the preferred embodiment, the core 42 is a particle of quartz sand. The rubber coating material 44 in the preferred embodiment is a thermoplastic polymer having a melt index that is substantially within a range of about 20 to about 40 g/10 min and more preferably within a range of about 25 to about 35 g/10 min. The melt index is measured as grams of melt in 10 minutes according to the test procedure defined in the ASTM standard D1238 Procedure A.

The material from which the rubber particles 46 and/or the particles 40 of rubber coated hard granular material is fabricated may be impregnated with a substance that inhibits the growth of bacteria and/or mold. Alternatively, a coating of such a substance may be applied to the external surface of the rubber particle 46 and/or to the external surface of the particles 40 of rubber coated hard granular material.

The material from which the rubber particles 46 and/or the particles 40 of rubber coated hard granular material is fabricated preferably has a static frictional coefficient relative to other particles of the same composition that is within a range of about 0.9 to about 3.0 and is more preferably within a range of about 1.0 to about 2.5. This relatively high frictional engagement between the individual particles reduces the amount of mixing and settling of the particles that will occur after installation and as a result of extended use of the recreational surface.

The hardness testing of plastics is most commonly measured by the Shore test. The Shore hardness is measured with an apparatus known as a Durometer and consequently is also known as Durometer hardness. The ASTM test number is ASTM D2240 while the analogous ISO test method is ISO 868. This method measures the resistance of the material against indentation and provides an empirical hardness value that is the preferred method for quantifying the hardness of natural and artificial rubbers as well as other elastomers and is also commonly used for ‘softer’ plastics such as polyolefins, fluoropolymers, and vinyls. The Shore A scale is typically used for ‘softer’ rubbers while the Shore D scale is used for ‘harder’ ones. The rubber coating material 44 in the preferred embodiment is preferably a thermoplastic polymer that has a Shore A hardness that is substantially within a range of about 40 to about 90, more preferably within a range of about 50 to about 80, and most preferably within a range of about 60 to about 75.

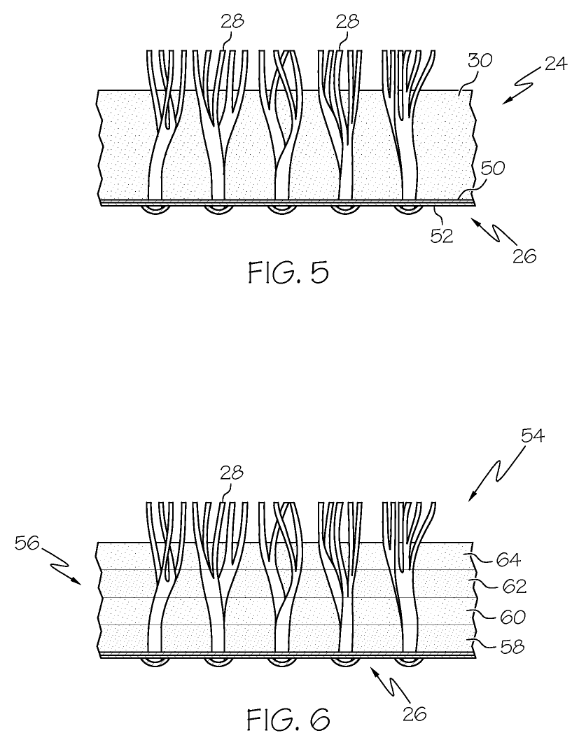

Referring now to FIG. 5, artificial turf assembly 24 according to a first embodiment of the invention includes a pile fabric having a backing 26. Backing 26 preferably includes a first layer 50 of a woven material and a second layer 52 of a nonwoven material, and a multiplicity of generally upstanding pile elements or fibers 28, which are preferably tufted to the backing material 26 as is illustrated in FIG. 5. Artificial turf assembly 24 also preferably includes an infill 30, which is preferably a substantially homogeneous mixture of particles 40 of rubber coated hard granular material and rubber particles 46. The rubber particles 46 and the particles 40 of rubber coated hard granular material preferably are size to have outer diameters that are substantially the same. The rubber material that is used in the particles 40 of rubber coated hard granular material is preferably a different material than the rubber material that is used to fabricate the rubber particles 46, with the material that is used to fabricate the rubber particles 46 preferably having a greater weight density than the rubber material that is used to fabricate the particles 40 of rubber coated hard granular material. The core particles 42 of hard granular material are likely to have greater weight density than either of the rubber materials that are used to fabricate the rubber particles 46 and the outer rubber coating 44 of the particles 40 of rubber coated hard granular material. Accordingly, by using a denser material for the rubber particles 46 the average weight density of the rubber particles 46 and the particles 40 of rubber coated hard granular material may be constructed so as to be substantially the same. This is considered preferable, as it will minimize post installation layering and separation between the two types of particles, which could otherwise change or degrade the performance of the artificial turf installation.

In order to improve the binding between the grain and the coating material, so that the particulate material is less sensitive to wear, it is considered preferable to provide a coupling agent between the silica sand grains and the rubber coating material. Such coupling agents are characterized by having an improved adherence to the surface of the sand grain as well as to the elastomeric coating material as compared to the adherence between the elastomeric coating material and the grain surface when being in direct contact. One preferred coupling agent is bifunctional silane comprising a reactive amino group and a hydrolyzable inorganic triethoxysilyl group, so that the silane binds to inorganic materials, i.e. the sand grains, as well as to organic polymers, i.e. the elastomeric coating material. A preferred bifunctional silane is 3-aminopropyltriethoxysilane (H₂N—(CH₂)₃—Si(OC₂H₅)₃), which is sold by the company Degussa under the trade name of Dynasylan Ameo. The silane is typically applied in a thin layer on the surface of the sand grains in an amount of about 0.05 to about 0.5% by weight of the sand, and more preferably in an amount of about 0.1 to about 0.3% by weight. Other preferred coupling agents are EDA-based terpolymers (ethylene-acrylic derivatives) ethylene-acrylic ester+maleic anhydride terpolymer, in particular defined as terpolymer comprising glycidyl methacrylate (GMA) groups or terpolymer comprising maleic anhydride (MAH) groups. One particularly preferred material is ethylene-butyl acrylate-maleic anhydride terpolymer, sold by the company Atofina under the trade name of Lotader 3410. Typically, this terpolymer is applied in a thin layer on the surface of the sand grains in an amount of 0.3-2% by weight of the sand, preferably in an amount of 0.5-1.5% by weight. The coupling agent constitutes a part of the above-mentioned coating material, so that the indicated preferred weight range of the coating material includes the thermoplastic polymer as well as the coupling agent. These coupling agents may preferably be applied on the surface of the sand grains, but may alternatively be mixed in a polymer, such as a phenolic, furan or melamine resin which is applied to the sand grain in a thin layer before the coating with the elastomeric coating material, or the coupling agent may be admixed with the elastomeric coating material before it is applied as a coating to the sand grains. Combinations of the mentioned coupling agents with each other or with other coupling agents may alternatively be applied.

The rubber coated sand particles may be produced by a method that is disclosed in WO 2004/022853 to Jensen, namely by heating a portion of silica sand to a temperature within the range of about 200° to about 300° C., and more preferably about 230° to about 2700, placing the portion of sand in a mixer, adding a portion of a thermoplastic polymer to the content of the mixer, adding a predetermined amount of water to the content of the mixer as it continues to operate, and directing an airflow through the content of the mixer so as to lower the temperature thereof. By heating the sand to such a high temperature, a very advantageous and even distribution of the coating is obtained. By adding water to the mixture of sand and the thermoplastic polymer, a rapid cooling to just above about 100° C. may be obtained, whereby the distribution as well as the properties of the coating is secured. The water is dried out of the mixture by means of the airflow through the content of the mixer and the temperature is lowered further, e.g. below 80° C. and more preferably below 60° C., so that the coated grains are no longer mutually bonded and a loose, particulate product is obtained. The predetermined amount of water may be about 3 to about 15% by weight of the sand, more preferably about 5 to about 10% by weight of the sand, and most preferably between about 6.5 to about 8.5% by weight of the sand.

A coupling agent as discussed above may be added to the mixer prior to the thermoplastic polymer, so as to provide a layer of the coupling agent on the surface of the silica sand grains before the thermoplastic polymer is added to the content of the mixer, thereby improving the binding between the grain and the thermoplastic polymer.

A recreational surface according to a second embodiment of the invention is depicted in FIG. 6. In this embodiment, a pile fabric having a backing 26 and a multiplicity of generally upstanding pile elements 28 that are otherwise identical to those described above with reference to the first embodiment are first installed. An infill 56 is then installed in separate and distinct layers. In the embodiment of FIG. 6, this is performed by first installing a first infill layer 58 that is predominantly fabricated from particles 40 of the rubber coated hard granular material. More preferably, the first infill layer 58 is at least 60% by weight of the particles 40 of the rubber coated hard granular material. Most preferably, the first infill layer 58 consists entirely of the particles 40 of rubber coated hard granular material.

After installation of the first infill layer 58, a second infill layer 60 is installed directly on top of the first infill layer 58. Preferably, the second infill layer 60 is predominantly fabricated of rubber particles 46. More preferably, the second infill layer 60 is at least 60% by weight made up of the rubber particles 46. Most preferably, the second infill layer 60 consists entirely of rubber particles 46. The second infill layer 60 accordingly will preferably have different composition than the first infill layer 58, and the weight percentage of particles of the rubber coated hard granular material in the second infill layer 60 will be different than in the first infill layer 58.

Both the rubber particles 46 and the particles 40 of rubber coated hard granular material are preferably pigmented with a colorant that gives the particles a surface coloration that is preferably an earth tone color such as tan, light green or brown. This coloration helps keep the artificial turf assembly cool and also gives it an attractive appearance.

After installation of the second infill layer 60, a third infill layer 62 is installed directly on top of the second infill layer 60. Third infill layer 62 is preferably predominantly fabricated from particles 40 of the rubber coated hard granular material. More preferably, the third infill layer 62 is at least 60% by weight of the particles 40 of the rubber coated hard granular material. Most preferably, the third infill layer 62 consists entirely of the particles 40 of rubber coated hard granular material.

After installation of the third infill layer 62, a fourth infill layer 64 is preferably installed directly on top of the third infill layer 62. The fourth infill layer 64 is preferably predominantly fabricated of rubber particles 46. More preferably, the fourth infill layer 64 is at least 60% by weight made up of the rubber particles 46. Most preferably, the fourth infill layer 64 consists entirely of rubber particles 46.

In this embodiment of the invention, each of the infill layers 58, 60, 62, 64 is preferably constructed so as to be substantially devoid of any abrasive material such as uncoated sand.

The embodiment of the invention described above may be modified by installing fewer or more than four separate layers of infill material. For example, an infill according to the invention may include a first infill layer that is predominantly fabricated of particles of rubber coated hard granular material and a second infill layer that is predominantly fabricated of rubber particles without the installation of additional layers.

According to another important aspect of the invention, a method of fabricating a recreational surface includes determining a desired property of the recreational surface and fabricating the recreational surface using a mixture of rubber particles and particles of a rubber coated hard granular material. The relative proportion of the rubber particles with respect to the particles of rubber coated hard granular material is, according to the invention, selected in accordance with the desired property of the recreational surface. The desired property of the recreational surface may be a shock absorbing property of the recreational surface. The shock absorbing property of the recreational surface may be adjusted by varying the relative proportion of the rubber particles with respect to the particles of rubber coated hard granular material, with a greater proportion of rubber particles being associated with increased shock absorption properties.

As has been described above, impact testing (commonly referred to as Gmax testing) is used to measure the shock-absorbing properties of recreational surfaces, including artificial turf. Gmax values express a ratio: the ratio of the maximum acceleration (deceleration) experienced during an impact with the surface undergoing testing, to the normal rate of acceleration due to gravity. The higher the Gmax value, the lower the shock-absorbing properties of the surface. Gmax measurements are an important measurement of the playability and safety of an artificial turf playing field. The most commonly used Gmax testing standard is the one established by the American Society for Testing and Materials (ASTM). For synthetic surfaces, the ASTM specifies that the average Gmax value of one or more test points on a field should not exceed 200 Gmax (as measured in accordance with ASTM procedures F355-A and F1936). If Gmax level of over 200 is measured, the field is considered unsafe and remediation is required.

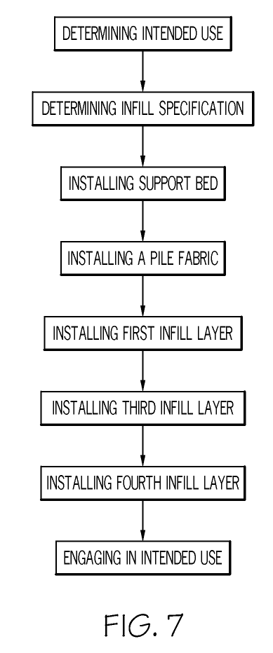

According to another important aspect of the invention as is depicted in FIG. 7, a method of fabricating an artificial turf installation may be performed by determining an intended use of the artificial turf installation, installing a pile fabric having a backing 26 and a multiplicity of generally upstanding pile elements 28 as described above, determining a specification for an infill in a manner that considers or relies at least partially on the intended use of the artificial turf installation, and installing an infill according to that specification. More specifically, the specification of the infill may be selected according to the type of recreational or athletic activity that is intended to take place within the artificial turf installation. In addition, the length of the multiplicity of generally upstanding pile elements 28 and the depth and weight density of the infill may be selected in a manner that considers or relies at least partially on the intended use of the artificial turf installation.

Preferably, the Gmax value of the playing field for lower impact sports such as field hockey and baseball would be selected to be within a range of about 115-200, with a more preferred range being about 135-165. For higher impact sports such as lacrosse, football and soccer, a preferred Gmax value of the playing field would be about 90-160, with a more preferred range being about 100-145.

The Gmax value of the playing field may be adjusted to the desired value by selecting a base installation for the playing field and by adjusting the proportion of rubber particles to particles of rubber coated hard granular material in the infill of the playing field. By selecting the base installation that is described with reference to FIG. 2 and that has a layer of shock absorbing material 39, it is possible to achieve a lower Gmax rating than it is with the base installation that is described above with reference to FIG. 1, all other factors being equal. When the base installation described with reference to FIG. 2 is used, a Gmax range from about 80 to about 150 is achievable depending on infill thickness and weight density, the proportion of rubber coated hard granular material to rubber particles in the infill, and the composition and thickness of the layer of shock absorbing material 39. Such a low Gmax value is particularly suitable for higher impact sports such as lacrosse, football and soccer when being played by younger athletes such as children. A more preferred Gmax rating for high impact children's sports would be about 80-135, while a more preferred Gmax rating for high impact adult sports using the base installation described with reference to FIG. 2 would be about 100-150.

### EXAMPLE 1

A playing field was fabricated using artificial turf that is constructed of a pile fabric having a backing and a multiplicity of generally upstanding pile elements, with each of the generally upstanding pile elements being approximately 2 inches in length, plus or minus about ⅛ of an inch. A base installation was provided according to the embodiment of FIG. 1 described above. An infill was installed that is made up of a homogeneous mixture of approximately 75% by weight particles of rubber coated hard granular material and 25% by weight rubber particles. The infill was applied over the backing of the pile fabric so as to be interspersed between the multiplicity of generally upstanding pile elements and at a density of approximately 4 pounds per square foot. This installation yielded a Gmax rating of about 138. This particular installation is considered to have particular utility for higher impact sports such as lacrosse, football and soccer.

A comparable installation to that described in Example 1 utilizing an infill made up of all rubber particles applied at a weight density of 3 pounds per square foot was measured to have Gmax rating of 115. Another comparable installation utilizing an infill made up of all rubber coated hard granular material particles applied at a weight density of 4 pounds per square foot was measured to have Gmax rating of 172. These examples show how it is possible according to the teachings of the invention to adjust the Gmax rating of the artificial turf installation by adjusting the relative proportions of rubber coated hard granular material and rubber particles that are used in the artificial turf in infill. The higher the relative proportion of rubber coated hard granular material particles to rubber particles, the higher the Gmax rating of the artificial turf installation will be.

### EXAMPLE 2

A playing field was fabricated using artificial turf that is constructed of a pile fabric having a backing and a multiplicity of generally upstanding pile elements, with each of the generally upstanding pile elements being approximately 1.5 inches in length, plus or minus about ⅛ of an inch. A base installation was provided according to the embodiment of FIG. 1 described above. An infill was installed that was made up of a homogeneous mixture of approximately 50% by weight particles of rubber coated hard granular material and 50% by weight rubber particles. The infill was applied over the backing of the pile fabric so as to be interspersed between the multiplicity of generally upstanding pile elements and was applied at a density of approximately 2 pounds per square foot. This installation yielded a Gmax rating of about 160. This installation is considered to have particular utility for lower impact sports, such as baseball and field hockey. A comparable installation having an infill made up of all rubber particles applied at a weight density of 1.5 pounds per square foot had a Gmax rating of 148.

### EXAMPLE 3

A playing field would be fabricated using artificial turf that is constructed of a pile fabric having a backing and a multiplicity of generally upstanding pile elements, with each of the generally upstanding pile elements being approximately 2 inches in length, plus or minus about ⅛ of an inch. A base installation would be provided according to the embodiment of FIG. 2 described above. An infill would be installed that was made up of a homogeneous mixture of approximately 50% by weight particles of rubber coated hard granular material and 50% by weight rubber particles. The infill would be applied over the backing of the pile fabric so as to be interspersed between the multiplicity of generally upstanding pile elements and at a density of approximately 2 pounds per square foot. This installation would be expected to yield a Gmax rating of about 90. This particular installation would be considered to have particular utility for higher impact sports such as lacrosse, football and soccer and particularly for children playing such sports.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of fabricating a recreational surface, comprising:
determining a desired property of the recreational surface; and
fabricating the recreational surface using a mixture comprising rubber particles and a particles of a rubber coated hard granular material, and wherein said step of fabricating the recreational surface comprises selecting a relative proportion of said resilient particles with respect to said particles of a rubber coated hard granular material based on said desired property.

2. A method of fabricating a recreational surface according to claim 1, wherein said desired property comprises a shock absorbing property of said recreational surface.

3. A method of fabricating a recreational surface according to claim 2, wherein said step of selecting a relative proportion of said resilient particles with respect to said particles of a rubber coated hard granular material comprises selecting a higher proportion of said resilient particles in order to increase a shock absorbing property of said recreational surface.

4. A method of fabricating a recreational surface according to claim 1, wherein said rubber coated hard granular material comprises rubber coated sand.

5. A method of fabricating artificial turf, comprising:
installing a pile fabric having a backing and a multiplicity of generally upstanding pile elements;
installing a first infill layer on said backing, said first infill layer being predominantly fabricated from one of either or particles of rubber coated hard granular material; and
installing a second infill layer over said first infill layer, said second infill layer being predominantly fabricated from the other of either resilient particles or particles of rubber coated hard granular material.

6. A method of fabricating artificial turf according to claim 5, wherein said first infill layer is predominantly fabricated from said particles of rubber coated hard granular material.

7. A method of fabricating artificial turf according to claim 6, wherein said first infill layer is at least 60% by weight particles of rubber coated hard granular material.

8. A method of fabricating artificial turf according to claim 6, wherein said first infill layer consists essentially of said particles of rubber coated hard granular material.

9. A method of fabricating artificial turf according to claim 6, wherein said second infill layer is at least 60% by weight rubber particles.

10. A method of fabricating artificial turf according to claim 6, wherein said second infill layer consists essentially of rubber particles.

11. A method of fabricating artificial turf according to claim 5, further comprising a step of installing a third infill layer over said second infill layer and wherein said third infill layer is predominantly fabricated from said one of either resilient particles or particles of rubber coated hard granular material.

12. A method of fabricating artificial turf according to claim 11, further comprising a step of installing a fourth infill layer over said third infill layer, and wherein said fourth infill layer is predominantly fabricated from the other of either resilient particles or particles of rubber coated hard granular material.

13. A method of fabricating an artificial turf installation, comprising:
determining an intended use of the artificial turf installation;
calculating an optimum shock absorbing property specification for the artificial turf installation, said step of calculating an optimum shock-absorbing property specification being performed in reliance upon said determined intended use;
calculating an infill composition in reliance on said shock-absorbing property specification, said infill composition comprising a mixture of first particles having a first hardness and second particles having a second hardness that is different from said first hardness, and wherein said step of calculating an infill composition comprises determining a ratio of said first particle to said second particles;
installing a pile fabric having a backing and a multiplicity of generally upstanding pile elements; and
installing an infill constructed according to said calculated infill composition on said backing.

14. A method of fabricating an artificial turf installation according to claim 13, wherein said step of calculating an optimum shock absorbing property specification is performed in reliance upon an activity that is anticipated to occur on said artificial turf installation.

15. A method of fabricating an artificial turf installation according to claim 14, wherein said step of calculating an optimum shock absorbing property specification is further performed in reliance upon which specific sports activity that is anticipated to occur on said artificial turf installation, and is further performed in reliance upon anticipated characteristics of players that are anticipated to engage in the specific sports activity.

16. A method of fabricating an artificial turf installation according to claim 15, wherein said anticipated characteristics of players is selected from the group consisting of age, experience and skill level.

17. A method of fabricating an artificial turf installation according to claim 13, wherein said first particles are fabricated from a rubber material having a first hardness and said second particles have a second hardness that is greater than said first hardness.

18. A method of fabricating an artificial turf installation according to claim at 17, wherein said second particles comprise a rubber coated hard granular material.

19. A method of fabricating an artificial turf installation according to claim 13, wherein said step of calculating an infill specification comprises determining a proportion of infill material that that is to be fabricated from particles of rubber coated hard granular material.

20. A method of fabricating an artificial turf installation according to claim 13, wherein said step of calculating an infill specification further comprises specifying an infill that is substantially free of uncoated sand.

21. A method of fabricating artificial turf installation according to claim 13, wherein said step of calculating an infill specification comprises specifying an infill that consists essentially of particles of rubber coated hard granular material and rubber particles.

22. A method of fabricating an artificial turf installation according to claim 13, wherein said step of calculating an infill specification comprises specifying at least two layers of infill material, said at least two layers having different compositions, and wherein at least one of said layers is specified as containing a proportion of particles of rubber coated hard granular material.

23. A method of fabricating an artificial turf installation according to claim 22, wherein said at least one of said layers is specified as containing at least 60% by weight particles of rubber coated hard granular material.

24. A method of fabricating an artificial turf installation according to claim 22, wherein at least one of said layers is fabricated predominantly by rubber particles.

25. A method of fabricating an artificial turf installation according to claim 24, wherein said layer that is fabricated predominantly by resilient particles is specified as containing at least 60% by weight rubber particles.

26. A method of fabricating an artificial turf installation according to claim 13, wherein said step of determining an intended use of the artificial turf installation comprises determining that the artificial turf installation is intended to be used for a sports activity selected from the group consisting of soccer, football and lacrosse, and wherein said step of calculating an optimum shock absorbing property specification for the artificial turf installation is performed to calculate an optimum Gmax rating that is within the range of about 50 to about 160.

27. A method of fabricating an artificial turf installation according to claim 26, wherein said step of calculating an optimum shock absorbing property specification for the artificial turf installation is performed to calculate an optimum Gmax rating that is within the range of about 80 to about 145.

28. A method of fabricating an artificial turf installation according to claim 13, wherein said step of determining an intended use of the artificial turf installation comprises determining that the artificial turf installation is intended to be used for a sports activity selected from the group consisting of field hockey and baseball, and wherein said step of calculating an optimum shock absorbing property specification for the artificial turf installation is performed to calculate an optimum Gmax rating that is within the range of about 115 to about 200.

29. A method of fabricating an artificial turf installation according to claim 26, wherein said step of calculating an optimum shock absorbing property specification for the artificial turf installation is performed to calculate an optimum Gmax rating that is within the range of about 135 to about 165.
